(19) United States
(12) Patent Application Publication
(10) Pub. No.: US 2006/0227805 A1
(43) Pub. Date: Oct. 12, 2006

(54) Buffers handling multiple protocols

(75) Inventors: John M. Hedin, Coon Rapids, MN (US); Donald R. Bauman, Waseca, MN (US); Jeffrey J. Cannon, St. Louis Park, MN (US)

Correspondence Address: FOGG AND ASSOCIATES, LLC, P.O. BOX 581339, MINNEAPOLIS, MN, 55458-1339, US

(73) Assignee: ADC Telecommunications, Inc., Eden Prairie, MN (US)

(21) Appl. No.: 11/094,949

(22) Filed: Mar. 31, 2005

(51) Int. Cl. H04J 15/00

(52) U.S. Cl. 370/464

(57) ABSTRACT

The present invention relates to buffers that handle multiple protocols in a communication system. In one embodiment, a plurality of communication channels is provide. There is a buffer for each communication channel. Moreover, each buffer is adapted to pass data samples in more than one protocol.

### CROSS REFERENCES TO RELATED APPLICATIONS

This application is related to the following co-pending United States patent applications filed on even date herewith, all of which are hereby incorporated herein by reference:

U.S. patent application Ser. No. ______ (attorney docket number 100.672US01 entitled “DYNAMIC FREQUENCY HOPPING”) and which is referred to here as the '672 application;

U.S. patent application Ser. No. ______ (attorney docket number 100.673US01 entitled “DYNAMIC DIGITAL UP AND DOWN CONVERTERS”) and which is referred to here as the '673 application;

U.S. patent application Ser. No. ______ (attorney docket number 100.675US01 entitled “DYNAMIC RECONFIGURATION OF RESOURCES THROUGH PAGE HEADERS”) and which is referred to here as the '675 application;

U.S. patent application Ser. No. ______ (attorney docket number 100.676US01 entitled “SIGNAL ENHANCEMENT THROUGH DIVERSITY”) and which is referred to here as the '676 application;

U.S. patent application Ser. No. ______ (attorney docket number 100.677US01 entitled “SNMP MANAGEMENT IN A SOFTWARE DEFINED RADIO”) and which is referred to here as the '677 application;

U.S. patent application Ser. No. ______ (attorney docket number 100.678US01 entitled “TIME STAMP IN THE REVERSE PATH”) and which is referred to here as the '678 application;

U.S. patent application Ser. No. ______ (attorney docket number 100.680US01 entitled “TIME START IN THE FORWARD PATH”) and which is referred to here as the '680 application;

U.S. patent application Ser. No. ______ (attorney docket number 100.681US01 entitled “LOSS OF PAGE SYNCHRONIZATION”) and which is referred to here as the '681 application;

U.S. patent application Ser. No. ______ (attorney docket number 100.684US01, entitled “DYNAMIC REALLOCATION OF BANDWIDTH AND MODULATION PROTOCOLS” and which is referred to here as the '684 application;

U.S. patent application Ser. No. ______ (attorney docket number 100.685US01 entitled “DYNAMIC READJUSTMENT OF POWER”) and which is referred to here as the '685 application;

U.S. patent application Ser. No. ______ (attorney docket number 100.686US01 entitled “METHODS AND SYSTEMS FOR HANDLING UNDERFLOW AND OVERFLOW IN A SOFTWARE DEFINED RADIO”) and which is referred to here as the '686 application; and

U.S. patent application Ser. No. ______ (attorney docket number 100.700US01 entitled “INTEGRATED NETWORK MANAGEMENT OF A SOFTWARE DEFINED RADIO SYSTEM”) and which is referred to here as the '700 application.

### TECHNICAL FIELD OF THE INVENTION

The present invention relates generally to communication systems and in particular with buffers handling multiple protocols in a communication system.

### BACKGROUND OF THE INVENTION

Wireless telecommunications systems, particularly cellular telephone communications systems, employ strategically placed base stations having transceivers that receive and transmit signals over a carrier frequency band to provide wireless communications between two parties. Recent mobile communication standards have lead to a plurality of different modulation standards being in use within a geographic region. Wireless communication providers have had to adapt their network hardware to accommodate unique protocols associated with each modulation standard. Some modulation standards that wireless communication networks currently operate with include, but are not limited to, Advanced Mobile Phone System (AMPS), code division multiple access (CDMA), Wide-band CDMA (WCDMA), time division multiple access (TDMA), Global System for Mobile communications (GSM), Cellular Digital Packet Data (CDPD), Enhanced Data rates for GSM Evolution (EDGE), General Packet Radio Service (GPRS), Integrated Digital Enhanced Network (iDEN), and Orthogonal Frequency Division Multiplexing (OFDM).

Current communication systems typically have dedicated hardware for each standard which results in idle resources at times when network demand for a particular standard is low. Moreover, typical base stations have limited resources dedicated to specific frequencies, bandwidths, and amplitudes for particular protocols. These resources communicate with remote units that are operating with the same protocol. Accordingly, when the use of different protocols are required in a current communication system, an inefficient use of the limited resources occurs.

For the reasons stated above, and for other reasons stated below that will become apparent to those skilled in the art upon reading and understanding the present specification, there is a need in the art for a method of providing a dynamic protocol communication system.

### SUMMARY

The above-mentioned problems and other problems are resolved by the present invention and will be understood by reading and studying the following specification.

In one embodiment, a communication system is provided. The communication system includes a plurality of communication channels and a buffer for each communication channel. Each buffer is adapted to pass data samples in more than one protocol.

In another embodiment, a method of passing data samples in a multi-channel communication system is provided. The method includes passing a first set of data samples in a first protocol though a first buffer in a first communication channel and passing a second set of data samples in a second protocol through a second buffer in a second communication channel.

In further another embodiment, a method of passing data samples in communication channels in a communication system is provided. The method comprises passing a first data samples having a first protocol through a first buffer. Changing the protocol of the first data samples to a second protocol and passing the first data samples having the second protocol through the first buffer.

In yet another embodiment, a communication system is provided. The communication system comprises a forward path and a reverse path. The forward path includes a plurality of forward communication channels. Moreover, the forward path includes a forward buffer for each communication channel. Each forward buffer is adapted to pass data samples having more than one protocol type. The reverse path includes a plurality of reverse communication channels. Moreover, the reverse path includes a reverse buffer for each communication channel. Each reverse buffer is adapted to pass data samples having more than one protocol type.

In further still another embodiment, a method of operating a communication system is provided. The method comprises passing pages of data samples through a plurality of forward communication channels. Each forward communication channel includes a forward buffer adapted to handle pages of data samples having different protocols. Changing the protocol of pages of data samples in at least one forward communication channel. Passing pages of data samples through a plurality of reverse communication channels. Each reverse communication channel includes a reverse buffer adapted to handle pages of data samples having different protocols. Changing the protocol of pages of data samples in at least one reverse communication channel.

### BRIEF DESCRIPTION OF THE DRAWINGS

The present invention can be more easily understood and further advantages and uses thereof more readily apparent, when considered in view of the description of the preferred embodiments and the following figures in which:

FIG. 1 is a block diagram illustrating one embodiment of the present invention; and

FIG. 2 is a flow diagram illustrating a method of operating buffers in one embodiment of the present invention.

In accordance with common practice, the various described features are not drawn to scale but are drawn to emphasize specific features relevant to the present invention. Reference characters denote like elements throughout Figures and text.

### DETAILED DESCRIPTION

In the following detailed description of the present embodiments, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that logical, electrical or mechanical changes may be made without departing from the scope of the present invention. The following detailed description is, therefore, not to be taken in a limiting sense, and the scope of the present invention is defined only by the appended claims and equivalents thereof.

In embodiments of the present invention first in first out buffers (FIFO's) in a communication system are adapted to dynamically handle data samples having multiple protocol types. Moreover, embodiments provide a communication system that includes multiple communication channels that are adapted to independently pass communication signals in a unique protocol format simultaneously. In addition, embodiments of the present invention allow for FIFO's to pass dynamically changing data sample protocols.

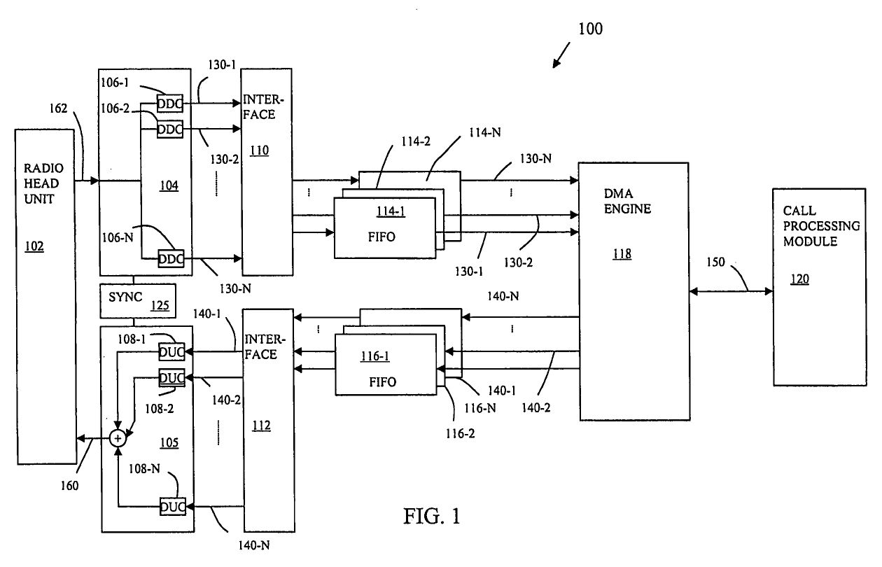

Referring to FIG. 1, a communication system 100 of one embodiment of the present invention is illustrated. The communication system includes a forward and a reverse communication path. In the forward path, communication signals are passed from the call processing module 120 to the radio head unit 102. In the reverse path, communication signals are passed from the radio head unit 102 to the call processing module 120. The communication signals are in the form of data samples that may be formed in an associated group or set such as a page of data samples. The forward path includes communication channels 140-1 though 140-N. The reverse path includes communication channels 130-1 through 130-N.

The call processing module 120 is adapted to interface and process communications between the communication system 100 and one or more communication networks. In operation, call processing software 102 includes algorithms to support channel hopping as well as protocol changing in communication channels. The call processing module is coupled to the direct memory access (DMA) engine 118 of the communication system 100. In one embodiment, the call processing module 120 is coupled to the DMA engine 118 via PCI-X bus. In other embodiments, other high speed parallel and serial busses are used such as ATCA, PCI express, gigabit Ethernet, SCSI, rocket I/O, UDP/IP, TCP/IP link, serial ATA, card bus (for PCMIA cards) and the like. The DMA engine 118 is adapted to perform data transfers between devices. The devices in this embodiment, are the call processing module 120 and first in first out (FIFO) buffers 116-1 though 116-N (buffers in the forward path) and buffers 114-1 through 114-N (Buffers in the reverse path).

Interface 112 is adapted to interface data samples between the forward buffers 116-1 through 116-N and a digital up converter (DUC) circuit 105. The DUC circuit contains a plurality of DUC's 108-1 through 108-N. In particular, there is one DUC for each forward channel. Interface 110 is adapted to interface data samples between a digital down converter (DDC) circuit 104 and reverse buffers 114-1 through 114-N. The DDC circuit 104 includes a plurality of DDC's 106-1 through 106-N. In particular, there is one DDC for each reverse channel. Each forward DUC 108-1 though 108N and each DDC 106-1 through 106-N is adapted to dynamically change the protocol of data samples passing through its associated communication channel. This is accomplished by changing the control parameters of the respective DUC 108-1 though 108N and DDC 106-1 through 106-N in response to commands from the call processing module 120. The control parameters include filter coefficients, numerically controlled oscillator (NCO) frequency, interpolation/decimation rates and sampling rates and the like.

In one embodiment, the call processing module 120 attaches a message in a head of a page of data samples that indicates a protocol to switch to and the time to make the switch. The synchronization control circuit 125 is adapted to read the message in the header and change the parameters in the designated DUC and DDC at the select time to change the protocol of select data samples. In embodiments of the present invention, each communication channel can be using its own unique communication protocol controlled by its associated DUC or DDC.

The radio head unit 102 is adapted to receive and transmit communication signals between the communication system 100 and remote units such cell phone, personal data assistants (PDA's) and the like. In particular, the radio head receives data samples to transmit in a select protocol from the DUC circuit 105 and receives data samples to pass to the DDC circuit 104 from remote units.

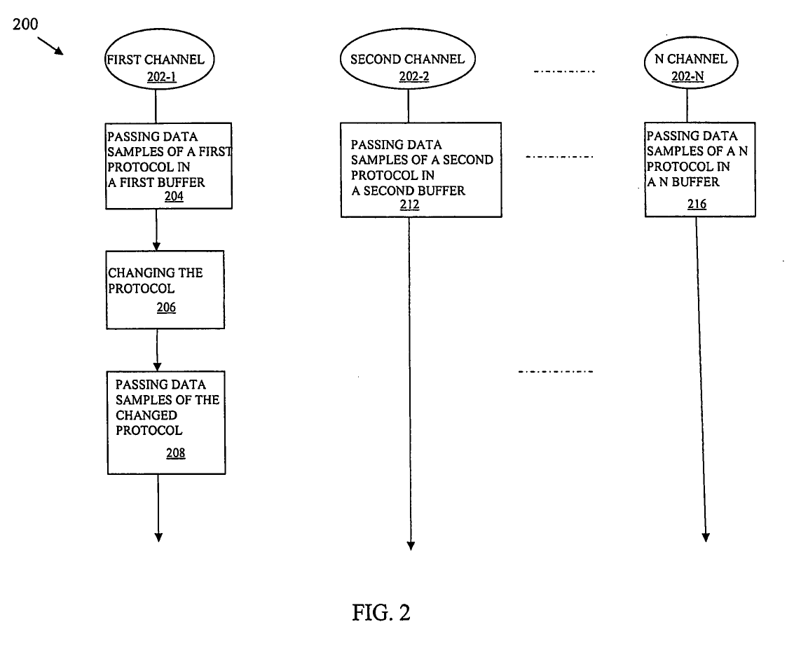

Referring to FIG. 2, a flow diagram 200 illustrating a method of operating buffers in one embodiment of the present invention is illustrated. In particular, flow diagram 200 illustrates the function of the buffers in select communication channels 202-1 through 202-N. As illustrated, in channel 202-1, the process starts by passing data samples of a first protocol through a first buffer (204). The protocol of the data samples in the first channel 202-1 is then changed (260). The data samples having the changed protocol are then passed through the first buffer (208). Meanwhile, as illustrated, in the second channel 202-2, data samples of a second protocol is passed through a second buffer (212) and in N channel 202-N, data samples of a N protocol is passed through a N buffer (216). This flow diagram illustrates that data samples passing through a buffer in a channel can change protocol as illustrated in the first channel 202-1. Also illustrated is that each channel can be passing data samples simultaneously having their own unique protocol.

Although specific embodiments been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. Accordingly, this application is intended to cover any such adaptations or variations of the invention. It is manifestly intended that this invention be limited only by the following claims and equivalents thereof.

What is claimed is:

1. A communication system comprising:
a plurality of communication channels; and
a buffer for each communication channel, each buffer adapted to pass data samples in more than one protocol.

2. The communication system of claim 1, wherein the protocol of data samples in one buffer is independent of the protocol of data samples in the other buffers.

3. The communication system of claim 1, further comprising:
a digital converter for each communication channel, each digital converter adapted to dynamically change the protocol of the data samples in an associated communication channel.

4. The communication system of claim 1, further comprising:
a synchronization control circuit adapted to replace parameters in the digital converters to change a protocol of a data samples based on a message in a group of data samples.

5. A method of passing data samples in a multi-channel communication system, the method comprising:
passing a first set of data samples in a first protocol though a first buffer in a first communication channel; and
passing a second set of data samples in a second protocol through a second buffer in a second communication channel.

6. The method of claim 5, further comprising:
dynamically changing the protocol in at least one of the first and second communication channels.

7. A method of passing data samples in communication channels in a communication system, the method comprising:
passing a first data samples having a first protocol through a first buffer;
changing the protocol of the first data samples to a second protocol; and
passing the first data samples having the second protocol through the first buffer.

8. The method of claim 7, further comprising:
passing second data samples having a third protocol through a second buffer.

9. The method of claim 7, wherein changing the protocol further comprises:
changing the parameters of an associated digital converter.

10. The method of claim 9, further comprising:
reading a message associated with the first data samples to determine the protocol to switch to.

11. A communication system comprising:
a forward path having a plurality of forward communication channels;
a forward buffer for each communication channel, each forward buffer adapted to pass data samples having more than one protocol type;
a reverse path having a plurality of reverse communication channels; and
a reverse buffer for each communication channel, each reverse buffer adapted to pass data samples having more than one protocol type.

12. The communication system of claim 11, wherein at least one forward buffer is adapted to pass data samples having a different protocol than the data samples in the other forward buffers.

13. The communication system of claim 11, wherein at least one reverse buffer is adapted to pass data samples having a different protocol than the data samples in the other reverse buffers.

14. The communication system of claim 11, further comprising:
a call process module adapted to process data samples and attached protocol messages to groups of associated data samples; and
a radio head adapted to communicate with remote units, the forward and reverse communication channels coupling the call process module to the radio head.

15. The communication system of claim 14 further comprising:
a digital up converter for each forward communication channel, each digital up converter adapted to dynamically change the protocol of the data samples in an associated forward communication channel; and
a digital down converter for each reverse communication channel, each digital down converter adapted to dynamically change the protocol of data samples in an associated reverse communication channel.

16. The communication system of claim 15, further comprising:
a control synchronizing circuit adapted to read the protocol messages and reconfigure select digital up converters and digital down converters based on associated protocol messages.

17. A method of operating a communication system, the method comprising:
passing pages of data samples through a plurality of forward communication channels, wherein each forward communication channel includes a forward buffer adapted to handle pages of data samples having different protocols;
changing the protocol of pages of data samples in at least one forward communication channel;
passing pages of data samples through a plurality of reverse communication channels, wherein each reverse communication channel includes a reverse buffer adapted to handle pages of data samples having different protocols; and
changing the protocol of pages of data samples in at least one reverse communication channel.

18. The method of claim 17, further comprising:
attaching a protocol message in a header of a page of data samples;
reading the protocol message in the header of the page of data samples; and
reconfiguring an associated digital converter to change the protocol of the page of data samples in an associated communication channel.

19. The method of claim 17, wherein the forward communication channels are adapted to pass pages of data samples having different protocols simultaneously.

20. The method of claim 17, wherein the reverse channels are adapted to pass pages of data samples having different protocols simultaneously.
